(19) United States
(12) Patent Application Publication
(10) Pub. No.: US 2020/0193737 A1
(43) Pub. Date: Jun. 18, 2020

(54) SYSTEM AND METHOD TO AUTOMATICALLY DETERMINE A DRIVING MODE OF A VEHICLE

(71) Applicant: General Motors LLC, Detroit, MI (US)

(72) Inventors: Ravikiran DHULLIPALA CHENCHU, Canton, MI (US); Aqueel HUSAIN, Troy, MI (US); David A. ADAMS, Troy, MI (US); Suchinder K. GOVINDAN, Farmington Hills, MI (US); Mirna NEVES, Windsor (CA)

(73) Assignee: General Motors LLC, Detroit, MI (US)

(21) Appl. No.: 16/217,532

(22) Filed: Dec. 12, 2018

(51) Int. Cl. G07C 5/08; G07C 5/00

(52) U.S. Cl. CPC G07C 5/085; G07C 5/008

(57) ABSTRACT

In an example, a system is disclosed. The system includes an event classification module that is configured to determine whether a vehicle event is an emergency event or a non-emergency event based on vehicle sensor data. The system also includes a determination module that is configured to determine a driving mode of a vehicle at the time of the vehicle event in response to a determination that the vehicle event is the emergency event. The determination module is configured to determine the driving mode by comparing a driving mode timestamp to an emergency timestamp corresponding to the vehicle event.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to determining a vehicle driving mode during an event.

Autonomous vehicles can have multiple driving modes. For example, these autonomous vehicles may have a manual driving mode in which the operator controls movement of the vehicle and an autonomous driving mode where a vehicle's control system controls movement of the vehicle. When an autonomous vehicle having multiple driving modes is involved in an event, multiple entities may want to determine which driving mode was active at the time of the event.

### SUMMARY

In an example, a system is disclosed. The system includes an event classification module that is configured to determine whether a vehicle event is an emergency event or a non-emergency event based on vehicle sensor data. The system also includes a determination module that is configured to determine a driving mode of a vehicle at the time of the vehicle event in response to a determination that the vehicle event is the emergency event. The determination module is configured to determine the driving mode by comparing a driving mode timestamp to an emergency timestamp corresponding to the vehicle event.

In other features, the driving mode timestamp comprises data representing a transition in the driving mode and a corresponding driving mode timestamp.

In other features, the determination module is further configured to determine whether the driving mode timestamp indicates that the driving mode transitioned to an automated driving mode prior to the emergency timestamp.

In other features, the determination module is further configured to determine whether the driving mode timestamp indicates that the driving mode transitioned from the automated driving mode to a manual driving mode prior to the emergency timestamp.

In other features, the event classification module is further configured to determine that the vehicle event was involved in the emergency event when the vehicle sensor data indicates at least one of (1) an airbag activation, (2) a change in velocity that is greater than a predetermined threshold, and (3) a vehicle rollover.

In other features, the system includes a sensor data receiving module that is configured to receive vehicle sensor data from the vehicle over a communication network.

In other features, the system includes an emergency event data module that is configured to receive the emergency timestamp from the vehicle after the event classification module determines that the vehicle event is the emergency event.

In other features, the system includes a drive mode data module that is configured to receive the drive mode timestamp from the vehicle after the event classification module determines that the vehicle event is the emergency event.

In other features, the determination module is further configured to store data representing the determined drive mode at the time of the vehicle event in a memory.

In other features, the determination module is further configured to selectively generate an electronic communication indicating the determined drive mode.

In an example, a method is disclosed. The method includes determining whether a vehicle event is an emergency event or a non-emergency event based on vehicle sensor data and determining a driving mode of a vehicle at the time of the vehicle event in response to a determination that the vehicle event is the emergency event by comparing a driving mode timestamp to an emergency timestamp corresponding to the vehicle event.

In other features, the driving mode timestamp comprises data representing a transition in the driving mode and a corresponding driving mode timestamp.

In other features, the method includes determining whether the driving mode timestamp indicates that the driving mode transitioned to an automated driving mode prior to the emergency timestamp.

In other features, the method includes determining whether the driving mode timestamp indicates that the driving mode transitioned from the automated driving mode to a manual driving mode prior to the emergency timestamp.

In other features, the method includes determining that the vehicle event was involved in the emergency event when the vehicle sensor data indicates at least one of (1) an airbag activation, (2) a change in velocity that is greater than a predetermined threshold, and (3) a vehicle rollover.

In other features, the method includes receiving vehicle sensor data from the vehicle over a communication network.

In other features, the method includes receiving the emergency timestamp from the vehicle after the determination that the vehicle event is the emergency event.

In other features, the method includes receiving the drive mode timestamp from the vehicle after the determination that the vehicle event is the emergency event.

In other features, the method includes storing data representing the determined drive mode at the time of the vehicle event in a memory.

In other features, the method includes generating an electronic communication indicating the determined drive mode.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is diagrammatic illustration of a system for determining a vehicle driving mode in accordance with an example implementation of the present disclosure;

FIG. 2 is a block diagram of a determination module in accordance with an example implementation of the present disclosure;

FIG. 3 is a flow diagram illustrating an example method for determining the vehicle driving mode in accordance with an example implementation of the present disclosure;

FIG. 4 is a flow diagram illustrating an example method for determining whether the vehicle was involved in an event in accordance with an example implementation of the present disclosure; and

FIG. 5 is a flow diagram illustrating an example method for determining whether the event was an emergency event in accordance with an example implementation of the present disclosure.

In the drawings, reference numbers may be reused to identify similar and/or identical elements.

### DETAILED DESCRIPTION

Vehicles typically record sensor data that may be used at a later time to determine circumstances related to a vehicle event, such as when the vehicle is involved in a crash. However, there can be delays in determining a vehicle driving mode at the time of the event due to amount of vehicle data recorded, which may take investigators hours or days to evaluate and arrive at a conclusion.

The present disclosure is directed to a system that remotely determines the vehicle driving mode when the vehicle was involved in an event. In some implementations, the system determines whether the event is an emergency event or a non-emergency event. In one or more implementations, the system can determine whether the event is the emergency event based on sensor data recorded by the vehicle. For example, the system can use the recorded sensor data to determine that the vehicle was involved in the emergency event when an airbag activated, a change in velocity or acceleration was greater than a predetermined threshold within a predetermined time period, or the vehicle was involved in a rollover.

If the event is determined to be the emergency event, the system requests and obtains driving mode timestamp data and emergency timestamp data. The system can then use the driving mode timestamp data and the emergency timestamp data to determine the driving mode at the time of the event.

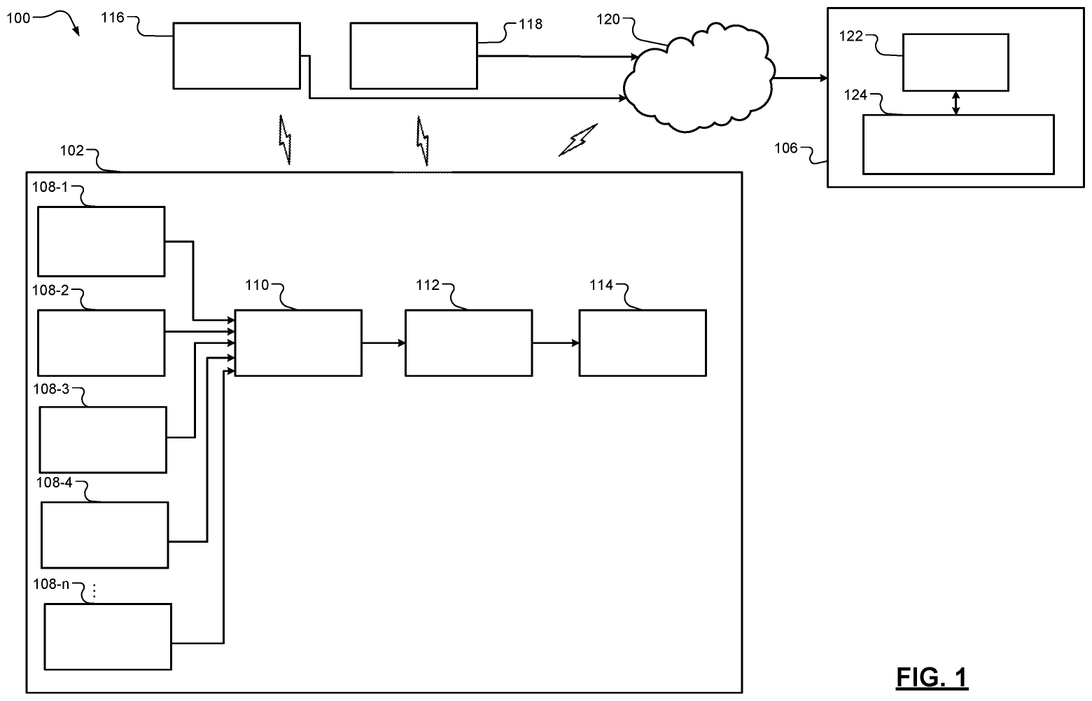

FIG. 1 illustrates an example system 100 that includes a vehicle 102, a communications network 104, and a server 106. The vehicle 102 can include any suitable vehicle such as a passenger car, a motorcycle, truck, sports utility vehicles, recreational vehicles, marine vessels, aircraft, or the like. The vehicle 102 can be capable of transitioning between driving modes. For example, the vehicle 102 can transition between manual driving mode and autonomous driving mode. In some implementations, a driver can provide input to transition between the driving modes. In other implementations, a vehicle control module can cause the vehicle 102 to transition between driving modes. The vehicle 102 may be characterized as a level one, a level two, a level three, or a level four autonomous vehicle.

The vehicle 102 includes multiple sensors 108-1 through 108-4 that detects or measures vehicle properties. As described herein, the vehicle properties can be used to determine a type of event when the vehicle 102 is involved in an event. For example, based on the vehicle properties, the server 106 can determine whether the vehicle 102 has been involved in an emergency event or a non-emergency event.

In an example implementation, the vehicle 102 can include an airbag activation sensor 108-1, a yaw-rate sensor 108-2, a speed sensor 108-3, and a side impact 108-4. The airbag activation sensor 108-1 can detect activation of an airbag. The yaw-rate sensor 108-2 measures an angular velocity of the vehicle 102. The speed sensor 108-3 measures can measure the speed of the vehicle 102. For example, the speed sensor 108-3 may be a wheel speed sensor that is mounted to a wheel of the vehicle 102 and measures the wheel speed. The side impact sensor 108-4 can detect whether the vehicle 102 has experienced a side impact. It is understood that the vehicle 102 may use additional sensors 108-n (where n is an integer greater than or equal to one) that measure other vehicle properties that can be used by the server 106 to determine the event type. For example, the sensors 108-n include GPS modules, image capture devices, and the like.

The vehicle 102 also includes a vehicle control module 110 that generates control signals for one or more vehicle components. For example, the vehicle control module 110 can cause the vehicle 102 to transition between driving modes. In some instances, the driving modes can be transitioned based on operator input or sensor data. The sensors 108-1 through 108-n transmit the sensor data to the vehicle control module 110. In some implementations, the vehicle control module 110 can record the sensor data.

The vehicle 102 also includes a communications module 112 including one or more transceivers that wirelessly receive information from and transmit information via one or more antennas 114 of the vehicle 102. Examples of transceivers include, for example, cellular transceivers, Bluetooth transceivers, WiFi transceivers, satellite transceivers, and other types of transceivers.

The vehicle control module 110 can provide the sensor data and driving mode data to the communications module 112 for transmission to the server 106. The antennas 114 can transmit the sensor data and the driving mode data to one or more communication networks. As shown in FIG. 1, the communication networks include a cellular communication network 116, a satellite communication network 118, and/or the Internet 120.

The server 106 includes a network interface 122 that connects the server 106 to one or more vehicles via the communications networks. The network interface 122 may include a wired interface (e.g., an Ethernet interface) and/or a wireless interface (e.g., a Wi-Fi, Bluetooth®, near field communication (NFC), or another wireless interface). For example, the server 106 can request and receive sensor data from the vehicle 102 via the network interface 122. The network interface 122 is connected to a determination module 124 that can determine the driving mode of the vehicle 102 using the sensor data.

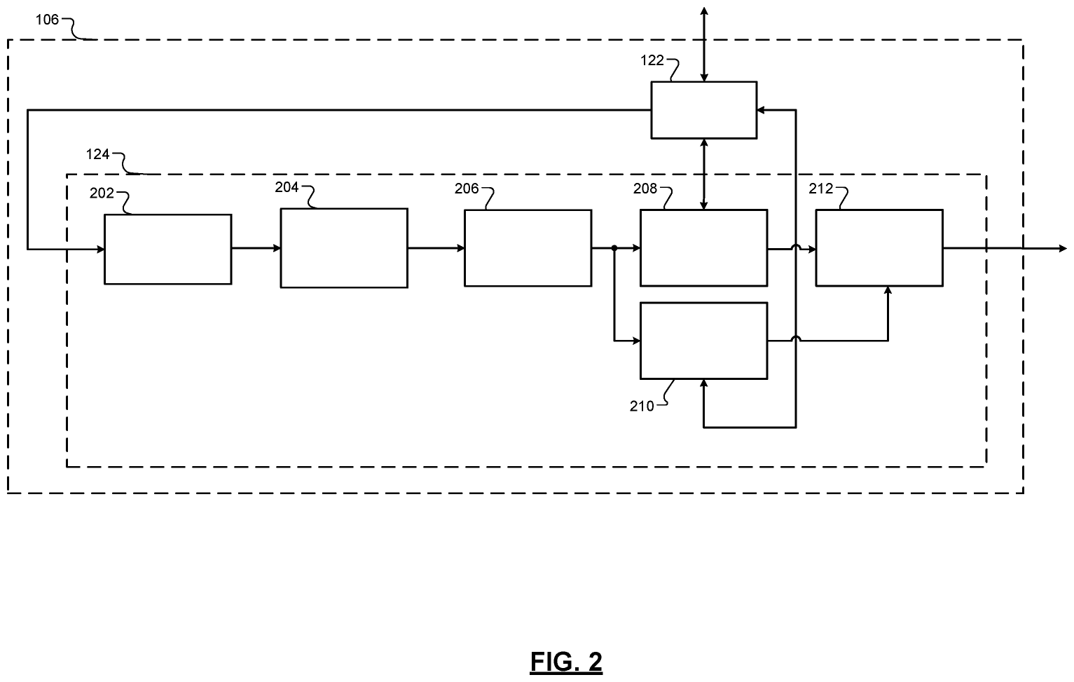

FIG. 2 illustrates a functional block diagram of the determination module 124 in accordance with an example implementation of the present disclosure. As shown, the determination module 124 includes a sensor data receiving module 202, an event detection module 204, an event classification module 206, an emergency event data module 208, a drive mode data module 210, and a determination module 212.

The sensor data receiving module 202 receives the sensor data, which can represent a state transition of the vehicle 102, from the communication module 112. For example, the sensor data can include, but is not limited to: data representing changes in vehicle velocity, data representing changes in vehicle acceleration, data representing a side impact collision, and/or data representing an airbag activation.

The event detection module 204 determines whether the vehicle 102 has been involved in an event, such as a crash. For example, the event detection module 204 receives the sensor data from the sensor data receiving module 202 and determines whether an event has occurred based upon the sensor data. In an implementation, the event detection module 204 determines the vehicle 102 has been involved in an event when an airbag activation has occurred, the vehicle 102 experiences a change in velocity and/or acceleration that is larger than a predetermined threshold within a predetermined time period, a collision is detected, or the vehicle 102 has been involved in a rollover.

When the event detection module 204 determines the vehicle 102 has been involved in an event, the event detection module 204 provides the sensor data to the event classification module 206. The event classification module 206 classifies the event based on the sensor data. In an implementation, the event classification module 206 determines whether the event is an emergency event or a non-emergency event. For example, the event classification module 206 classifies the event as an emergency event when the airbag activates, the change in vehicle velocity or acceleration is larger than the predetermined threshold within the predetermined time period, or the vehicle is involved in a rollover. The event classification module 206 classifies the event as a non-emergency event when the airbag does not activate, the change in vehicle velocity or acceleration is less than the predetermined threshold, and the vehicle is not involved in a rollover.

The event classification module 206 can transmits an event signal to the emergency event data module 208 when the event is detected. In response, the emergency event data module 208 requests emergency event timestamp data from the vehicle 102. The emergency timestamp data can include time stamp data corresponding to when the sensors 108-1 through 108-n detected the event, such as when the airbag activates, when the change in vehicle velocity or acceleration was greater than the predetermined threshold within the predetermined time period, or when the vehicle was involved in a rollover. After receiving the emergency event timestamp data from the vehicle 102, the emergency event data module 208 provides the received emergency event timestamp data to the determination module 212.

The event classification module 206 also transmits the event signal to the drive mode data module 210 when the event is classified as the emergency event or the non-emergency event. In response, the drive mode data module 210 requests driving mode data from the vehicle 102 via the network interface 122. The driving mode data can be provided by the control module 110 and includes data indicative of drive mode transitions and the corresponding time stamps indicating when the drive mode transition occurred. For example, the driving mode data can indicate that a drive mode of the vehicle 102 transitioned from an autonomous drive mode to manual drive mode, and vice versa, as well as the time when the drive mode transition occurred. The drive mode data module 208 provides the received driving mode data to the determination module 212. Thus, it is understood that the event classification module 206 can also transmit the event signals when the event is detected and not classified as the emergency event.

The determination module 212 determines a driving mode at the time of the event based on the emergency timestamp data and the driving mode data. In an implementation, the determination module 212 determines the driving mode at the time of the emergency event based on the emergency timestamp data and/or the timestamp of the driving mode data.

For example, the determination module 212 determines whether the driving mode timestamp data indicated a transition to automated driving mode prior the emergency timestamp data. If the determination module 212 determines that there was a transition to the automated driving mode prior to the emergency timestamp data during a driving event, the determination module 212 then determines whether the driving mode timestamp indicates a transition to the manual driving mode prior to the transition to automated driving mode. The driving event may be defined as a period of when the vehicle 102 is transitioned from an off state to an on state and then transitioned from the on state to the off state.

The determination module 212 determines that the vehicle 102 was operating in automated driving mode during the emergency event when the driving mode timestamp indicates that the transition to the manual driving mode occurred prior to the latest transition to the automated driving mode. Otherwise, the determination module 212 determines that the vehicle 102 was operating in manual driving mode during the emergency event.

The determination module 212 generates a driving mode signal indicative of the driving mode at the time of the emergency event. In one or more implementations, the driving mode signal can be stored in memory 214 for future access, transmitted to a display to indicate the driving mode at the time of the emergency event, or selectively generate an electronic communication based on the determined driving mode. In some implementations, the determination module 212 automatically generates an electronic communication that includes vehicle manufacturer, owner, and/or concerned party information regarding the entity responsible for driving the vehicle at the time of the crash. The electronic communications can be sent to an electronic device, such as another computing device, to assist personnel in determining technical information regarding possible factors involving the event. While functions described herein are being performed by the server 106, functionality of the server 106 may be distributed amongst two or more servers.

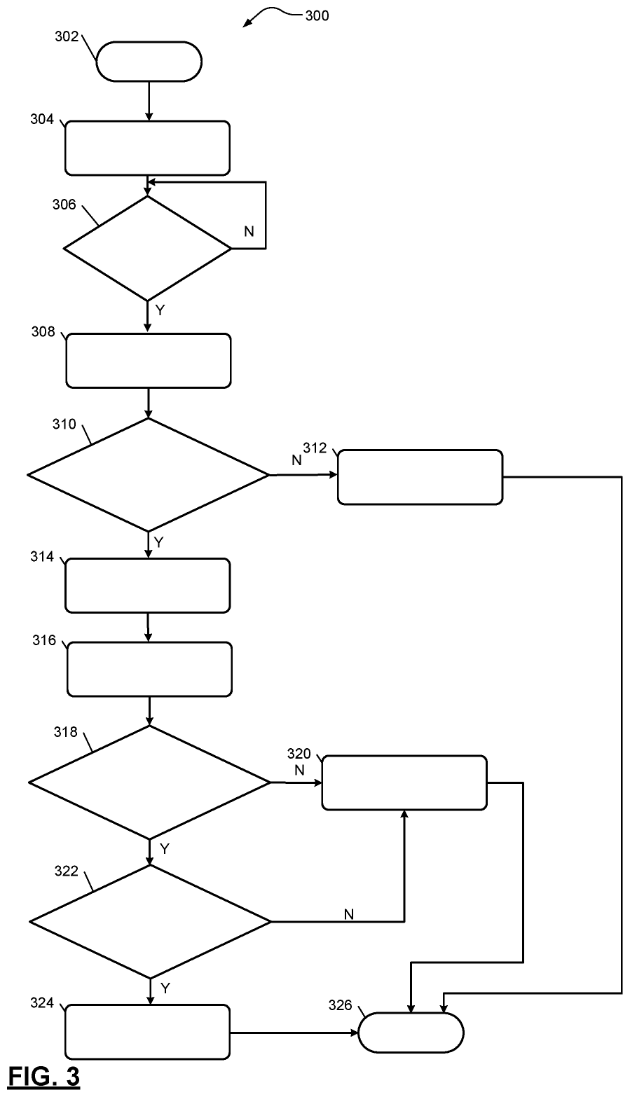

FIG. 3 illustrates an example method 300 for determining a driving mode of a vehicle during an event. The method 300 is described in the context of the modules included in the example implementation of the determination module 124 shown in FIG. 2 in order to further describe the functions performed by those modules. However, the particular modules that perform the steps of the method may be different than the description below and/or the method may be implemented apart from the modules of FIG. 2. For example, the method may be implemented by a single module.

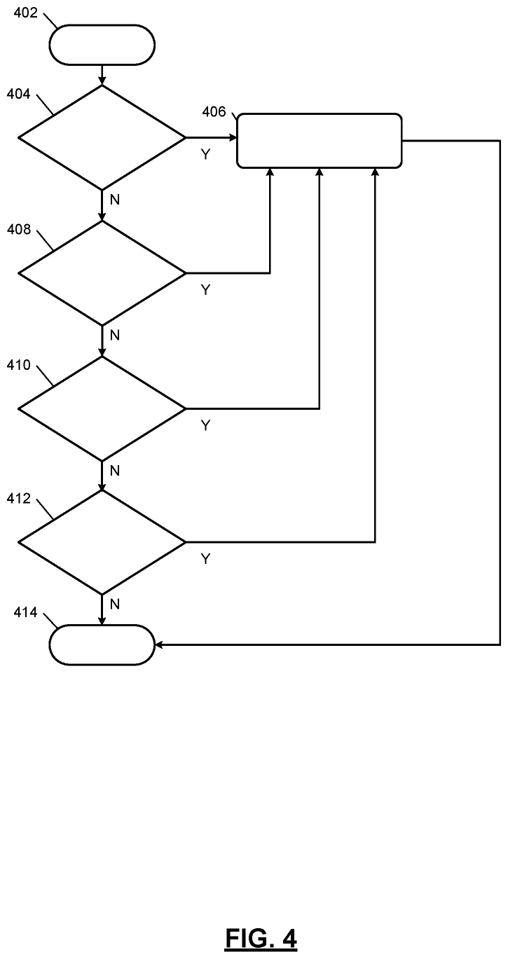

The method 300 starts at 302. At 304, the sensor data is received at the sensor data receiving module 202 from the communication module 112. At 306, the event detection module 204 determines whether the vehicle 102 has been involved in an event based on the sensor data, which is illustrated in FIG. 4. If the event detection module 204 determines that the vehicle 102 has been involved in an event, the sensor data is received at the event classification module 206 at 308. If the vehicle 102 has not been involved in an event, the method 300 returns to 306.

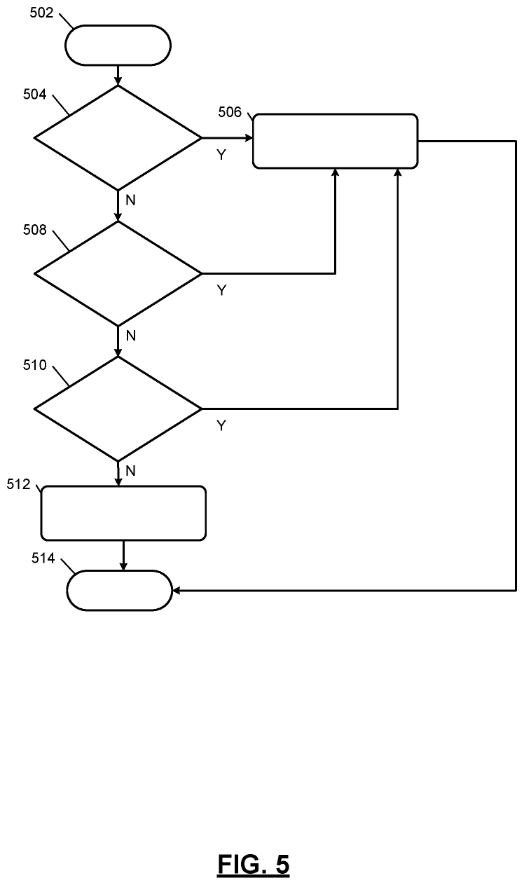

At 310, the event classification module 206 determines whether the event was the emergency event or the non-emergency event. For example, as shown in FIG. 5, the event classification module 206 determines whether the airbag activated, the change in vehicle velocity or acceleration was larger than the predetermined threshold, or whether the vehicle was involved in a rollover. If the event classification module 206 determines that the airbag did not activate, the change in vehicle velocity or acceleration was not larger than the predetermined threshold, and the vehicle was not involved in a rollover, the event classification module 206 determines that the event was a non-emergency event at 312.

If the event classification module 206 determines the airbag activated, the change in vehicle velocity or acceleration was larger than the predetermined threshold, or the vehicle was involved in a rollover, the emergency event data module 208 requests and obtains emergency event timestamp data from the vehicle 102 at 314. At 316, the drive mode data module 210 requests and obtains driving mode timestamp data from the vehicle 102.

At 318, the determination module 212 determines whether the driving mode timestamp indicates that a transition to automated driving mode occurred prior to the emergency timestamp data. If the determination is “NO” from 318, the determination module 212 determines that the vehicle 102 was in the manual driving mode at 320.

If the determination module 212 determines the driving mode timestamp data indicates that a transition to automated driving mode occurred prior to the emergency timestamp data, the determination module 212 then determines whether the driving mode timestamp data indicates that a transition to manual driving mode occurred prior to last transition to the automated driving mode at 322. If the determination is “NO” from 322, the determination module 212 determines that the vehicle 102 was in manual driving mode at 320. If the determination is “YES” from 322, the determination module 212 determines the vehicle 102 was in the automated driving mode at 324.

FIG. 4 illustrates an example method 400 for determining whether an event occurred according to an example implementation. The method 400 is described in the context of the modules included in the example implementation of the event detection module 204 shown in FIG. 2 in order to further describe the functions performed by those modules. However, the particular modules that perform the steps of the method may be different than the description below and/or the method may be implemented apart from the modules of FIG. 2. For example, the method may be implemented by a single module.

The method 400 begins at 402. At 404, the event detection module 204 determines whether the airbag activated. If the airbag activated, the event detection module 204 determines the vehicle 102 was in an event at 406. At 408, the event detection module 204 determines whether change in vehicle velocity or acceleration was larger than the predetermined threshold within the predetermined time period. If the change in velocity or acceleration was larger than the predetermined threshold within the predetermined time period, the event detection module 204 determines the vehicle was in an event at 406.

At 410, the event detection module 204 determines whether the vehicle 102 was involved in a collision. If the vehicle 102 was involved in a collision, the event detection module 204 determines the vehicle was in an event at 406. At 412, the event detection module 204 determines whether the vehicle 102 was involved in a rollover. If the vehicle 102 was involved in a rollover, the event detection module 204 determines the vehicle was in an event at 406. The method ends at 414.

FIG. 5 illustrates an example method 500 for determining whether the event was the emergency event according to an example implementation. The method 500 is described in the context of the modules included in the example implementation of the event classification module 206 shown in FIG. 2 in order to further describe the functions performed by those modules. However, the particular modules that perform the steps of the method may be different than the description below and/or the method may be implemented apart from the modules of FIG. 2. For example, the method may be implemented by a single module.

The method 500 begins at 502. At 504, the event classification module 206 determines whether the airbag activated. If the airbag activated, the event classification module 206 classifies the event as the emergency event at 506. At 508, the event classification module 206 determines whether the change in velocity or acceleration was larger than the predetermined change within the predetermined time period.

If the change in velocity or acceleration was larger than the predetermined change in speed threshold within the predetermined time period, the event classification module 206 classifies the event as the emergency event at 506. At 510, the event classification module 206 determines whether the vehicle 102 was involved in a rollover. For example, the event classification module 206 can use the yaw-sensor data to determine whether the vehicle 102 was involved in a rollover. If the vehicle 102 was involved in a rollover, the event classification module 206 classifies the event as the emergency event at 506. Otherwise, the event classification module 206 classifies the event as the non-emergency event at 512. The method ends at 514.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A system comprising:
an event classification module that is configured to determine whether a vehicle event is an emergency event or a non-emergency event based on vehicle sensor data; and
a determination module that is configured to determine a driving mode of a vehicle at a time of the vehicle event in response to a determination that the vehicle event is the emergency event, wherein the determination module is configured to determine the driving mode by comparing a driving mode timestamp to an emergency timestamp corresponding to the vehicle event.

2. The system as recited in claim 1, wherein the driving mode timestamp comprises data representing a transition in the driving mode and a corresponding driving mode timestamp.

3. The system as recited in claim 2, wherein the determination module is further configured to determine whether the driving mode timestamp indicates that the driving mode transitioned to an automated driving mode prior to the emergency timestamp.

4. The system as recited in claim 3, wherein the determination module is further configured to determine whether the driving mode timestamp indicates that the driving mode transitioned from the automated driving mode to a manual driving mode prior to the emergency timestamp.

5. The system as recited in claim 1, wherein the event classification module is further configured to determine that the vehicle event was involved in the emergency event when the vehicle sensor data indicates at least one of (1) an airbag activation, (2) a change in velocity that is greater than a predetermined threshold, and (3) a vehicle rollover.

6. The system as recited in claim 1, further comprising a sensor data receiving module that is configured to receive vehicle sensor data from the vehicle over a communication network.

7. The system as recited in claim 1, further comprising an emergency event data module that is configured to receive the emergency timestamp from the vehicle after the event classification module determines that the vehicle event is the emergency event.

8. The system as recited in claim 1, further comprising a drive mode data module that is configured to receive the drive mode timestamp from the vehicle after the event classification module determines that the vehicle event is the emergency event.

9. The system as recited in claim 1, wherein the determination module is further configured to store data representing the determined drive mode at the time of the vehicle event in a memory.

10. The system as recited in claim 1, wherein the determination module is further configured to selectively generate an electronic communication indicating the determined drive mode.

11. A method comprising:
determining whether a vehicle event is an emergency event or a non-emergency event based on vehicle sensor data; and
determining a driving mode of a vehicle at a time of the vehicle event in response to a determination that the vehicle event is the emergency event by comparing a driving mode timestamp to an emergency timestamp corresponding to the vehicle event.

12. The method as recited in claim 11, wherein the driving mode timestamp comprises data representing a transition in the driving mode and a corresponding driving mode timestamp.

13. The method as recited in claim 12, further comprising determining whether the driving mode timestamp indicates that the driving mode transitioned to an automated driving mode prior to the emergency timestamp.

14. The method as recited in claim 13, further comprising determining whether the driving mode timestamp indicates that the driving mode transitioned from the automated driving mode to a manual driving mode prior to the emergency timestamp.

15. The method as recited in claim 11, further comprising determining that the vehicle event was involved in the emergency event when the vehicle sensor data indicates at least one of (1) an airbag activation, (2) a change in velocity that is greater than a predetermined threshold, and (3) a vehicle rollover.

16. The method as recited in claim 11, further comprising receiving vehicle sensor data from the vehicle over a communication network.

17. The method as recited in claim 11, further comprising receiving the emergency timestamp from the vehicle after the determination that the vehicle event is the emergency event.

18. The method as recited in claim 11, further comprising receiving the drive mode timestamp from the vehicle after the determination that the vehicle event is the emergency event.

19. The method as recited in claim 11, further comprising storing data representing the determined drive mode at the time of the vehicle event in a memory.

20. The method as recited in claim 11, further comprising generating an electronic communication indicating the determined drive mode.
